(19) United States
(12) Patent Application Publication
(10) Pub. No.: US 2006/0182882 A1
(43) Pub. Date: Aug. 17, 2006

(54) Spin-coat application method, optical disk produced by the method, and spin-coat application apparatus

(75) Inventors: Shinsuke Takahashi, Kanagawa (JP); Takayoshi Ose, Kanagawa (JP); Satoshi Matsubaguchi, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/347,241

(22) Filed: Feb. 6, 2006

(30) Foreign Application Priority Data
Feb. 15, 2005 (JP) P.2005-037639

(51) Int. Cl. B05D 3/12; B05C 11/02

(52) U.S. Cl. 427/240; 118/52; 118/612

(57) ABSTRACT

A spin-coat application method wherein a coating liquid is spin-coat applied to a member to be coated in a condition where a processing atmosphere in a spin coater is humidified to a humidity of 60% or more by acidic water of pH 6 or less.

### FIELD OF THE INVENTION

The present invention relates to a method of applying a coating liquid onto a circular substrate by means of spin coat, and more particularly to a spin-coat application method performing application in which the thickness of a layer of a coating liquid is 100 μm or more, an optical disk produced by the method, and a spin-coat application apparatus.

### BACKGROUND OF THE INVENTION

As an optical information recording medium (optical disk) on which information can be recorded only once by a laser beam, usually, a recordable CD, a DVD-R, or the like is used. Such a disk has an advantage that, as compared with a conventional compact disk (CD), a small number of CDs can be promptly supplied to the market at a reasonable price. Therefore, a demand for such a disk is increased in accordance with recent popularization of personal computers and the like.

A typical optical information recording medium has a structure in which a recording layer made from an organic dye, a light reflecting layer made from a metal such as gold or silver, and a protective layer made from a resin are stacked in this sequence on a transparent disk-like substrate.

Recording (writing) of information on such an optical information recording medium is performed by illumination of a laser beam. Information is recorded on the basis of the phenomenon that the temperature of a portion of the dye recording layer which is irradiated with the laser beam is raised, and a physical or chemical change is caused in the portion to change the optical characteristic of the portion.

By contrast, reading of information is performed by illumination of a laser beam of the same wavelength as that of the recording laser beam. Information is reproduced by detecting a difference in reflectivity between a portion of the dye recording layer in which the optical characteristic has been changed and that in which the optical characteristic has not been changed.

In application of a coating liquid for a recording layer onto a disk-like substrate constituting an optical disk, therefore, it is crucial to maintain the air cleanness of an application chamber. In conventional spin coat application, because it dislikes dust, application is performed in a condition where the interior of a spinner is maintained to a low humidity. When the interior of a spinner is maintained to a low humidity, however, the coating liquid is easily dried, so that drying of the coating liquid is advanced before the liquid reaches the peripheral edge of the disk, or static electricity is easily generated. Therefore, it is difficult to evenly apply the coating liquid over the whole face of the substrate.

To comply with this, an invention has been disclosed in which, in order to reduce a fear that dust is produced in spin coat application, humidification is performed by using high-purity water or water having a large specific resistance, thereby simultaneously eliminating influences of static electricity and dust (see JP-A-2000-21018).

### SUMMARY OF THE INVENTION

In the invention of JP-A-2000-21018, however, the atmosphere in which the coating liquid is spun and scattered is always humidified by high-purity water. Therefore, the invention has problems that a large-scale facility is required, and that the production cost is increased.

The invention has been conducted with paying attention to a phenomenon that the thickness of a layer applied to a member to be coated is as large as 100 μm or more and both influences of dust and static electricity are very small, and in order to meet a request that the interior of a spinner is not to be dried when recovering an excess coating liquid which is not applied in a spin coating process and is shaken off to the peripheral area. It is an object of the invention to provide at a low cost an application method and apparatus in which humidification is performed by using water having a composition close to that of a coating liquid, thereby suppressing drying.

(1) In order to solve the problems, the invention provides a spin-coat application method wherein a coating liquid is spin-coat applied to a member to be coated in a condition where a processing atmosphere in a spin coater is humidified to a humidity of 60% or more by acidic water of pH 6 or less.

(2) In the spin-coat application method of (1), the acidic water is water containing at least one acidic solvent component of the coating liquid.

(3) In the spin-coat application method of (1) or

(2), the member to be coated is a printable surface of a printable optical disk.

(4) In the spin-coat application method of (3), a layer of the coating liquid applied to the printable surface has a thickness of 100 μm or more.

(5) The invention provides an optical disk wherein at least one layer of the printable surface is disposed by a spin-coat application method according to any one of (1) to (4).

(6) The invention provides a spin-coat application apparatus comprising: a spin coater; a coating liquid storage tank which stores a coating liquid to be supplied to the spin coater; and a humidifier which supplies moisture into the spin coater, wherein the apparatus further comprises: a humidity sensor which measures a humidity in the spin coater; a specific gravity meter which measures a specific gravity of the moisture to be supplied into the spin coater; a water supplying device which supplies pure water into the humidifier; and a liquid supplying device which supplies an acidic liquid into the humidifier, a humidifying amount of the humidifier is controlled in accordance with a detection value of the humidity sensor, and a water amount supplied from the water supplying device, and an acidic-liquid amount supplied from the liquid supplying device are controlled in accordance with a detection value of the specific gravity meter, whereby an interior of the spin coater is humidified to a humidity of 60% or more by acidic water of pH 6 or less.

(7) In the spin-coat application apparatus of (6), a surface of a coating liquid recovery wall which recovers the coating liquid scattered from the spin coater is made from a fluorine compound.

(8) In the spin-coat application apparatus of (6) or (7), the apparatus further comprises a recovery-liquid reflux device which ejects the coating liquid recovered from the coating liquid recovery wall, to an upper inner wall of the spin coater.

According to the configuration, an influence of dust is very small because the application layer thickness is relatively large, and also an effect of hardly charging the acidic water is attained. When humidification is performed by using water having a composition close to that of the coating liquid to suppress drying, therefore, the interior of a spinner is not dried when recovering excess liquid, and a reaction of the coating liquid is suppressed. Consequently, the quality is stabilized, a large-scale facility is not required, and the production cost can be held low.

### BRIEF DESCRIPTION OF THE DRAWINGS

FIG. 1 is a diagram showing a spin coater system of Embodiment 1 of the invention.

FIG. 2 is a plan view showing a manner of applying a coating liquid over the whole surface of a disk.

FIG. 3 is a diagram showing a spin coater system of Embodiment 3 of the invention.

### DESCRIPTION OF REFERENCE NUMERALS AND SIGNS

10 spin coater
11 spin coater housing
11b coating liquid recovery wall
11d coating liquid recovery tank
12 spin coater body
12a spin chuck
12b rotation shaft
13 motor
13b motor shaft
14 coating liquid dripping nozzle
15 control valve
15a valve controller
16 filter
20 coating liquid storage tank
21 pipe
22 pump
24 motor
30 humidifier
31 blow fan
32 water supplying pipe
33 liquid supplying pipe
34 humidifying pipe
35 feedback pipe
40 specific gravity meter
41 pH controller
42 control valve
43 control valve
50 ultrasonic wave generator
51 humidity controller
60 motor
61 pipe
62 pipe
D disk
S1 humidity sensor
W1 recovery moisture
T coating liquid

### DETAILED DESCRIPTION OF THE INVENTION

Hereinafter, the best mode for carrying out the invention will be described.

### EMBODIMENT 1

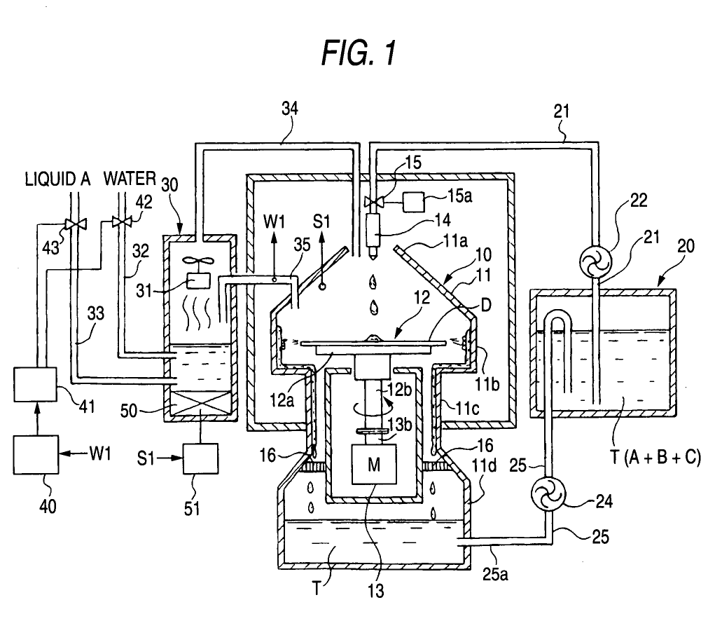

First, Embodiment 1 of the invention will be described with reference to FIG. 1.

FIG. 1 is a diagram showing a spin coater system of Embodiment 1 of the invention.

Referring to the figure, the spin coater system of Embodiment 1 is generally configured by a spin coater 10, a coating liquid storage tank 20, and a humidifier 30.

The spin coater 10 is configured by: a bottomed hollow jar-like spin coater housing 11 which is upward opened; a spin coater body 12 which is disposed at the center of the interior of the spin coater housing 11; and a filter 16 which filters a recovered coating liquid.

The spin coater housing 11 is upward opened. A coating liquid dripping nozzle 14 is disposed in the opening so that a coating liquid downward drips from the nozzle. A bottom portion of the spin coater housing 11 (11a) is conically spread as downward advancing from the opening. A cylindrical portion (11b) is a coating liquid recovery wall which, when a disk D (described later) on the spin coater body 12 rotates, captures the coating liquid T that is scattered from the outer periphery of the disk D. The filter 16 is disposed in a lower portion 11c of the coating liquid recovery wall 11b. The captured coating liquid is filtered by the filter, and then drops into a lower coating liquid recovery tank 11d. A drainage pipe 25a through which the captured coating liquid T is discharged to the coating liquid storage tank 20 is connected to the coating liquid recovery tank lid. The coating liquid T is discharged by a motor 24 into the coating liquid storage tank 20 through a drainage pipe 25.

The coating liquid storage tank 20 stores the coating liquid T. An example of the coating liquid T useful in the embodiment is an aqueous solution of fine particles of gas-phase silica (8.0 parts by weight), ion-exchange water (52.5 parts by weight), polyoxyethylene laulylether (3.0 parts by weight), polyvinyl alcohol aqueous solution (8%) (26.0 parts by weight), diethylene glycol monobutyl ether (0.5 parts by weight), and boric acid (8%) (10.0 parts by weight).

A pipe 21 elongates to the bottom of the coating liquid storage tank 20. The coating liquid T is sucked by a pump 22 through the pipe 21, and supplied to the coating liquid dripping nozzle 14.

The coating liquid dripping nozzle 14 is disposed above the center of the disk D with being downward directed, and drips an adequate amount of the coating liquid T via a control valve 15 the discharged amount of which is controlled by a controller 15a.

The spin coater body 12 has a disk-like spin chuck 12a which is disposed in a horizontal posture. The disk D is placed on the upper face of the disk-like spin chuck 12a, and vacuum-sucked by a vacuum sucking apparatus which is not shown. A rotation shaft 12b elongates from a center portion of the lower face of the spin chuck 12a, and is directly connected to a shaft 13b of a motor 13. By rotation of the motor 13, the disk-like spin chuck 12a is rapidly rotated, and therefore also the disk D which is a member to be coated is rapidly rotated.

When the coating liquid T drips from the coating liquid dripping nozzle 14 onto the disk D which is rapidly rotated, a large centrifugal force acts on the coating liquid T dripped onto the center portion of the disk D so that the surface area of the liquid is spread toward the outer periphery of the disk, thereby performing uniform application of the coating liquid T over the whole surface of the disk D.

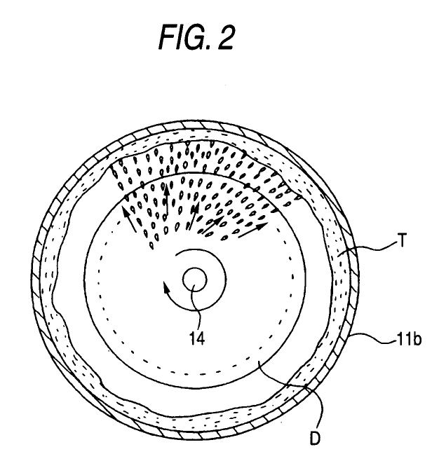

FIG. 2 is a plan view showing a manner of applying the coating liquid T over the whole surface of the disk D. Referring to the figure, the disk D is rapidly rotated about the axis of the coating liquid dripping nozzle 14. When the coating liquid dripping nozzle drips the coating liquid T onto the center of the disk D, a large centrifugal force acts on the dripped coating liquid T, and the surface area of the liquid is spread toward the outer periphery of the disk, thereby performing uniform application of the coating liquid T over the whole surface of the disk D. In the figure, in order to facilitate understanding, scattering liquid droplets (drips) are drawn only in the upper portion of the disk D (the range of 11 to 1 o'clock in the case of a clock). Actually, however, the droplet range is spread over 360 deg. or the whole circumference, and, instead of liquid droplets, is realized in the form of a coating liquid layer in which all liquid droplets are connected together.

When there is excess liquid in the coating liquid T which reaches the outer periphery of the disk as a result of the centrifugal force, the excess liquid is scattered in the tangential direction of the disk D therefrom, and the excess coating liquid T is collide with the coating liquid recovery wall 11b which is disposed around the disk D, to be captured thereby. The captured coating liquid T is caused by gravity to flow down along the recovery wall 11b (see FIG. 1). In mid-course, the liquid is filtered by the filter 16, and then recovered into the lower coating liquid recovery tank 11d.

In the upper opening of the spin coater housing 11, in addition to the coating liquid dripping nozzle 14, a tip end opening of a humidifying pipe 34 elongating from the humidifier 30 is disposed with being downward directed to humidify the interior of the spin coater housing 11. Furthermore, a feedback pipe 35 through which moisture-containing air is fed back into the humidifier 30 is opened.

In the conventional apparatus, the interior of the spin coater housing is set to a low humidity, or the interior is humidified by pure water. Both the conventional apparatuses have the above-discussed drawbacks. Therefore, the invention is characterized in that the interior is set to a condition where the interior is humidified to a humidity of 60% or more by acidic water of pH 6 or less which will be described later. In order to perform such a control, a humidity sensor S1 is disposed in the internal space of the spin coater body 12.

However, the sensor may be omitted in a condition where sufficiently stable humidification is ensured.

In the embodiment, the humidifier 30 performs humidification by means of an ultrasonic wave. The entire humidifier 30 is formed as a closed tank in which a water supplying pipe 32 for supplying pure water via a control valve 42, a liquid supplying pipe 33 for supplying an acidic aqueous solution via a control valve 43, and the humidifying pipe 34 for humidifying the interior of the spin coater body 12 are opened. In the humidifier 30, a blow fan 31 which feeds a predetermined amount of air into the spin coater body 12 is disposed in the vicinity of the humidifying pipe 34, and an ultrasonic wave generator 50 which generates steam by vibrating an ultrasonic transducer is disposed in a bottom portion.

The driving of the ultrasonic wave generator 50 is controlled by a humidity controller 51 which controls the humidity on the basis of a detection signal of the humidity sensor S1. The humidity controller 51 obtains the difference between the humidity detected by the humidity sensor S1 and a desired humidity, increases the number of vibrations of the ultrasonic wave generator 50 when the humidity is low, to make the humidity high, and on the contrary decreases the number of vibrations of the ultrasonic wave generator 50 when the humidity is higher than the desired humidity, to make the humidity low. The resulting air is fed by the blow fan 31 into the spin coater body 12 to humidify the interior to the desired humidity.

The reference numeral 40 denotes a specific gravity meter which detects the specific gravity of a recovery moisture W1 in the spin coater body 12 which is collected from the feedback pipe 35. In the invention, based on the fact that the pH concentration and specific gravity of the recovery moisture have a predetermined proportional relationship with each other, the pH concentration of the recovery moisture is easily obtained by measuring the specific gravity with using the specific gravity meter 40.

A pH controller 41 calculates a current pH value on the basis of the value of the specific gravity which is obtained by the specific gravity meter 40, and obtains the difference between the current pH value and a desired pH value. When the current pH value is lower than the desired pH value, the pH controller instructs the control valve 42 so as to supply a required amount of water, and, when the current pH value is higher than the desired pH value, the pH controller instructs the control valve 43 so as to supply a required amount of the acidic aqueous solution, so that the interior of the spin coater body 12 is always humidified by acidic water of pH 6 or less.

According to invention, the pH controller 41 controls the pH value, and the humidity controller 51 controls the humidity, whereby the interior of the spin coater body 12 can be always humidified to a humidity of 60% or more by the acidic aqueous solution of pH 6 or less. As the acidic aqueous solution, water of pH 6.0 or less and containing at least one solvent constituting the coating liquid is used, and spin coating is performed while humidifying the interior of the spin coater body 12 with the water. Therefore, a reaction of the coating liquid is suppressed, and hence the quality is stabilized.

As described above, according Embodiment 1 of the invention, with paying attention to the phenomenon that, when the pH is varied, the concentration is changed and also the specific gravity is changed, water is added to the recovered liquid, and the adding amount is adjusted while measuring the specific gravity.

### EXAMPLES AND COMPARATIVE EXAMPLES

When humidification is performed to a humidity of less than 60%, the capturing wall face is readily dried. In filtering, dried liquid is captured by the filter. Therefore, the capturing efficiency was lowered.
(1) When humidification was performed to a humidity of 60% or more, the capturing efficiency was improved. By contrast, when humidity was 50% or less, it was required to add water, and the facility was complicated.
(2) When humidification was performed with using water of pH 6 or less, the surface condition was satisfactory. By contrast, when humidification was performed with using water of pH 7.5 or more, precipitation was caused by a neutralization reaction, and filter clogging occurred.

### EMBODIMENT 2

In Embodiment 2, the surface of the coating liquid recovery wall 11b in FIG. 1 is finished as a surface made from a fluorine compound. When the coating liquid recovery wall 11b of the spinner has the water-repellent property (a contact angle of 100° or more) in this way, the coating liquid T adhering to the coating liquid recovery wall 11b is formed as a drop of water and rolls down. Therefore, the coating liquid T can be easily captured and hardly adheres to the wall. Consequently, there arises no phenomenon that the coating liquid recovery wall 11b is dried and deposition is produced thereon.

### EMBODIMENT 3

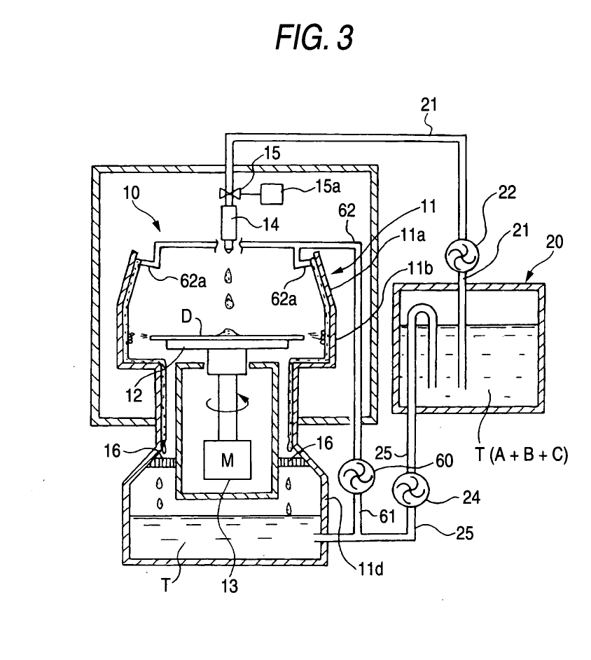

FIG. 3 is a diagram showing a spin coater system of Embodiment 3 of the invention.

Referring to the figure, the spin coater system of Embodiment 3 is generally configured by the spin coater 10, the coating liquid storage tank 20, and the humidifier 30. The system of the humidifier 30 is identical with that of Embodiment 1, and therefore not illustrated. In the spin coater 10 and the coating liquid storage tank 20, the components denoted by the same reference numerals as those of FIG. 1 have the identical functions, and therefore duplicated description will be omitted.

Embodiment 3 (FIG. 3) is different from Embodiment 1 (FIG. 1) in the following point. The drainage pipe 25 through which the captured coating liquid T is discharged from the lower coating liquid recovery tank 11d to the coating liquid storage tank 20 is partly branched to a pipe 61 so that the coating liquid T is fed by a motor 60 to a pipe 62. The tip ends of the pipe 62 are directed to the wall face 11a in the vicinity of the opening of the spin coater 10, whereby the coating liquid T is ejected to the wall face 11a in the vicinity of the opening. The ejected coating liquid T is caused to drop from the wall face. In the figure, only two or right and left tip ends of the pipe 62 are shown. Actually, however, many tip ends of the pipe 62 are disposed at regular intervals over a range of 360°. According to the configuration, all portions of the wall face 11a in the vicinity of the opening are maintained to be wetted by the coating liquid T, and a state where a curtain of the coating liquid is circulated along the inner wall is obtained. Therefore, the coating liquid is not dried, the filter is not clogged, and the recovery efficiency of the coating liquid is improved.

When the acidic water is water containing at least one acidic solvent component of the coating liquid, a chemical reaction between the coating liquid and the humidifying steam does not occur, and hence the filter is not clogged.

When the disk D which is the member to be coated of the spin-coat application method is a printable surface of a printable optical disk, the productivity is improved as compared with the conventional bar coating method.

As described above, according to the invention, the following effects are attained.
(1) Since a reaction of the coating liquid is suppressed, the quality is stabilized.
(2) Since drying of the coating liquid hardly occurs, efficient production is enabled by a simple recovery control system.

This application is based on Japanese Patent application JP 2005-37639, filed Feb. 15, 2005, the entire content of which is hereby incorporated by reference, the same as if set forth at length.

What is claimed is:

1. A spin-coat application method wherein a coating liquid is spin-coat applied to a member to be coated in a condition where a processing atmosphere in a spin coater is humidified to a humidity of 60% or more by acidic water of pH 6 or less.

2. The spin-coat application method according to claim 1, wherein said acidic water contains at least one acidic solvent component of said coating liquid.

3. The spin-coat application method according to claim 1, wherein said member to be coated is a printable surface of a printable optical disk.

4. The spin-coat application method according to claim 3, wherein a layer of said coating liquid applied to said printable surface has a thickness of 100 μm or more.

5. An optical disk wherein at least one layer of a printable surface is disposed by the spin-coat application method as claimed in claim 1.

6. A spin-coat application apparatus comprising: a spin coater; a coating liquid storage tank for storing a coating liquid to be supplied to said spin coater; and a humidifier for supplying moisture into said spin coater, wherein
said apparatus further comprises:
a humidity sensor for measuring a humidity in said spin coater;
a specific gravity meter for measuring a specific gravity of the moisture to be supplied into said spin coater;
a water supplying device for supplying pure water into said humidifier; and
a liquid supplying device for supplying an acidic liquid into said humidifier,
a humidifying amount of said humidifier is controlled in accordance with a detection value of said humidity sensor, and a water amount supplied from said water supplying device, and an acidic-liquid amount supplied from said liquid supplying device are controlled in accordance with a detection value of said specific gravity meter, whereby an interior of said spin coater is humidified to a humidity of 60% or more by acidic water of pH 6 or less.

7. The spin-coat application apparatus according to claim 6, further comprising a coating liquid recovery wall for recovering the coating liquid scattered from said spin coater, wherein a surface of said coating liquid recovery wall is made from a fluorine compound.

8. The spin-coat application apparatus according to claim 7, wherein said apparatus further comprises a recovery-liquid reflux device for ejecting the coating liquid recovered from said coating liquid recovery wall, to an upper inner wall of said spin coater.
